(19) United States
(12) Patent Application Publication
(10) Pub. No.: US 2005/0150153 A1
(43) Pub. Date: Jul. 14, 2005

(54) INSECTICIDE PRESENTATION DEVICE

(76) Inventor: James Conroy, Great Neck, NY (US)

Correspondence Address: WILLIAM COLLARD;COLLARD & ROE, P.C., 1077 NORTHERN BOULEVARD, ROSLYN, NY, 11576, US

(21) Appl. No.: 10/906,967

(22) Filed: Mar. 14, 2005

Related U.S. Application Data
(63) Continuation-in-part of application No. 10/034,041, filed on Dec. 20, 2001, now Pat. No. 6,898,897.

(51) Int. Cl. A01M 1/20

(52) U.S. Cl. 43/131

(57) ABSTRACT

A device for presenting insecticide. The device includes a body, at least one channel and a plurality of protrusions extending out from the body. The body can have a circular, triangular, square or any other polygonal shape. The body can also be formed as an elongate member wherein the at least one channel extends along a longitudinal axis of this body.

### CROSS REFERENCE TO RELATED APPLICATIONS

This application is a continuation in part application of U.S. patent application Ser. No. 10/034,041 filed Dec. 20, 2001, the disclosure of which is incorporated herein by reference.

### BACKGROUND OF THE INVENTION

When an exterminator enters a home, that exterminator must comply with EPA, OHSA, and other rules or laws when dispensing insecticide within a home. To ease the requirement levels for the exterminator the present invention relates to an insecticide presentation device that is designed to help an exterminator comply with a series of stringent rules as described above. Essentially, the invention relates to an insecticide presentation device that contains a body, and a series of spikes or protrusions to elevate the body away from a surface.

### SUMMARY OF THE INVENTION

The present invention was designed to overcome the problems of the art by presenting an omnidirectional insecticide presentation device containing a series of protrusions or spikes extending out therefrom. Thus the device can be positioned so that it can be laid down in any direction and still be effective. The presentation device acts as a body containing a series of crevasses, elongated indentations, or channels having an outer surface for receiving an insecticide. This device can receive an insecticide that is injected as a gel into these indentations. Once the gel is inserted into these indentations, the device can then be thrown behind furniture, appliances, up into ceiling tiles, under cabinets or any other place that would be necessary to rid of bugs. Other materials for use as insecticide may be used such as a spray or a solid strip.

The presentation device contains a series of protrusions in the form of ridges, spikes, or bumps that keep the indentations or crevasses away from a particular surface such as a wall, a floor or a ceiling tile. It is important to keep these indentations that have been treated away from these surfaces to allow insects access to the insecticides housed in these indentations.

The body of this device can be shaped such that it resembles a football, with an oval cross section, a pyramid, with a triangular cross section, a sphere with a circular cross-section, or block-shaped with a substantially rectangular cross section.

For example, the device can include a base having a surface with a plurality of substantially straight elongated indentations each having a surface for receiving insecticide. In addition, the device can include a plurality of spacing elements, which can be in the form of protrusions. The device can be designed so that when placed on a surface, at least two of the spacing elements can extend out from the surface on the base in a substantially vertical manner, in a substantially opposite direction from each other, and at least two spacing elements of the plurality of spacing elements can extend from the surface on the base in a substantially horizontal manner, in a substantially opposite direction from each other. The substantially vertically extending protrusions are for spacing the body away from substantially horizontal surfaces while the substantially horizontally extending elements spacing the body away from substantially vertically extending surfaces.

Before the device is placed in an area, the user can insert an insecticide on at least one of the plurality of elongated indentations so that the insecticide is disposed on an exterior surface of the base and is freely exposed for interaction with the insects wherein the plurality of spacing elements are used to keep the insecticide off of, and spaced away from a corresponding adjacent substantially horizontal or vertical surface.

Thus, the process for presenting this insecticide can be as follows: inserting the insecticide, which can be in the form of a gel substance into at least one of the indentations, channels or crevasses on the body. Next the body is placed on a surface such that at least two of the protrusions extend in a substantially vertical manner and at least two of the protrusions extend in a substantially horizontal manner. These protrusions can be formed on either or both sides of the channels, indentations or crevasses to keep these channels, crevasses or indentations spaced apart from an adjacent surface. The substantially vertically extending protrusions keep the body spaced away from substantially horizontally extending surfaces such as the ground or a cabinet floor, while the substantially horizontally extending protrusions are used to keep the body spaced away from the substantially vertically extending walls.

If these protrusions or spacing elements were not present on the body, then the channels or indentations carrying the insecticide would be pressed against a surface thereby keeping it away from the insects rendering that insecticide ineffective.

### BRIEF DESCRIPTION OF THE DRAWINGS

Other objects and features of the present invention will become apparent from the following detailed description considered in connection with the accompanying drawings, which disclose two embodiments of the present invention. It should be understood, however, that the drawings are designed for the purpose of illustration only and not as a definition of the limits of the invention.

In the drawings wherein similar reference characters denote similar elements throughout the several views:

FIG. 1A is a cross-sectional view of a first embodiment of the invention;

FIG. 1B is a cross-sectional view of a second embodiment of the invention;

FIG. 1C is a cross sectional view of the third embodiment of the invention;

FIG. 1D is a cross sectional view of the fourth embodiment of the invention;

FIG. 2A is a side view of the first embodiment of the invention;

FIG. 2B is a front view of the first embodiment of the invention;

FIG. 2C is a front view of the fifth embodiment of the invention; and

FIG. 2D is a side view of the fifth embodiment of the invention.

### DETAILED DESCRIPTION OF THE PREFERRED EMBODIMENT

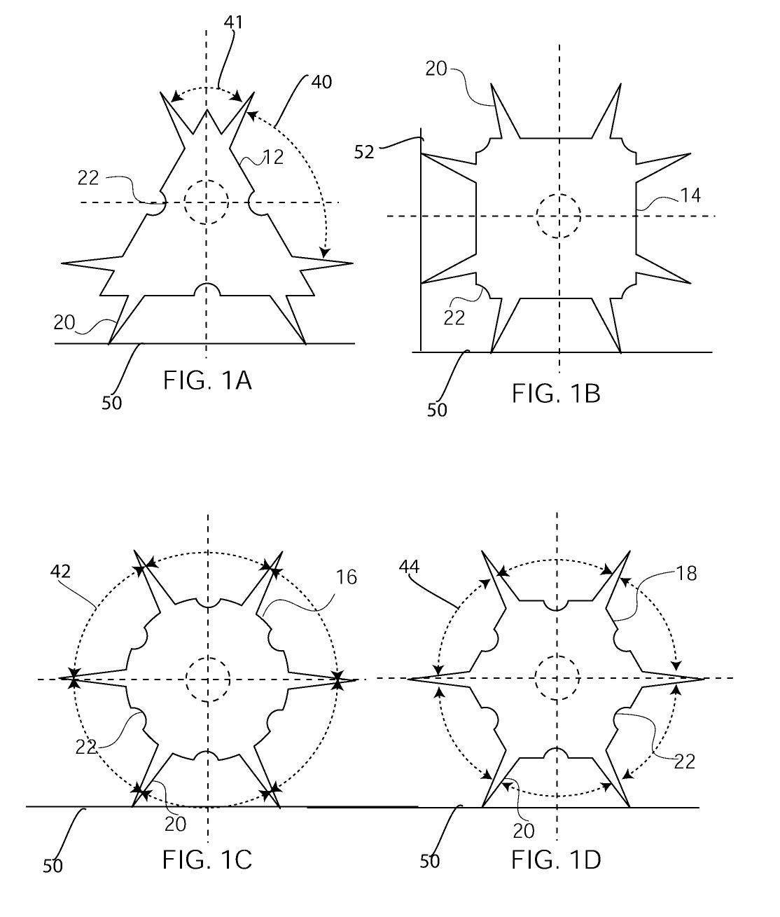

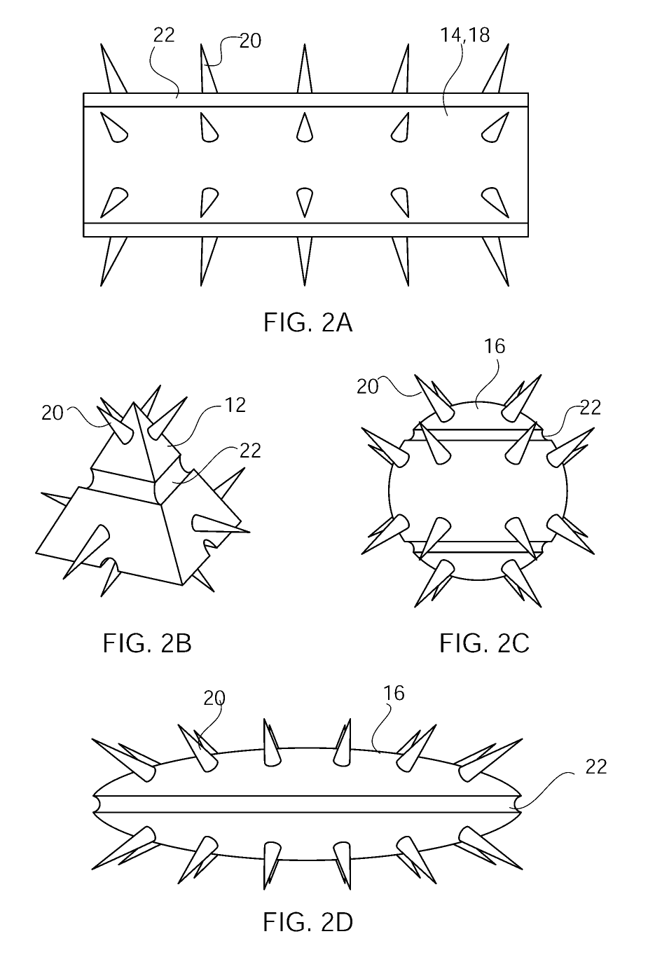

FIGS. 1A, 1B, 1C, and 1D show side cross-sectional views of the first four embodiments of the invention. FIG. 2A shows a side view of FIG. 1B, FIG. 2B shows a side view of FIG. 1A, FIG. 2C shows a side view of FIG. 1C, while FIG. 2D shows a side view of FIG. 1C. These different embodiments show some of the different possible shapes for the cross sections of these devices 10. For example the device can have a body 12 having a triangular cross section and shaped like a prism or a pyramid as shown in FIG. 2B.

FIG. 1B shows a second design of a body 14 which has a square or rectangular cross section and can be formed as an elongated member shown in FIG. 2A.

Finally, FIG. 1D shows a fourth design of a body 18 having a hexagonal cross section which can be formed as an elongated member shown in FIG. 2A.

All of the above embodiments contain a series of spikes or protrusions 20 extending out from this device such that they keep the body of this device away from a particular surface such as a wall, floor or ceiling tile. In addition all of these embodiments contain at least one channel 22 in which an insecticide can be injected therein. These channels extend along the length of the body and provide a region for housing this insecticide. Reviewing the device from the cross-sectional views shown in FIGS. 1A-1D there are shown at least three protrusions 20 and at least three crevasses, indentations or channels 22 spaced across an entire radial rotation such that these three protrusions keep the body of the device spaced apart from an adjacent surface. Therefore, in the first embodiment, shown in FIG. 1A, viewing from the cross section, at least two of the protrusions are spaced apart from each other by at least 100 degrees of rotation as shown by radial line 40, around an entire 360 degree radial rotation. In this design, there can be an unequal radial distance for the spacing of two other of these protrusions shown by radial line 41. In this case, the channels 22 are spaced apart from each other by at least 100 degrees and more particularly by approximately 120 degrees. In the second embodiment as shown in FIG. 1B, the channels 22 are spaced apart from each other by at least 75 degrees of rotation and more approximately 90 degrees of rotation. This second embodiment can also reveal an unequal radial spacing of the protrusions.

In another set of embodiments of the invention such as that shown in FIGS. 1C and 1D, the channels 22 are radially spaced apart from each other by at least 50 degrees and approximately 60 degrees. In these two embodiments, the radial spacing 42 and 44 can be substantially similar in length.

In three of the embodiments shown in FIGS. 1B, 1C and 1D, the bisecting vertical and horizontal lines show that the device is substantially symmetrical in cross section with the bisecting lines showing that at least one half of the body, protrusions and channels can be symmetrical with an opposite half of the body protrusions and channels.

As with all of the shapes of these embodiments, the design is such that all of these embodiments can either be placed, or thrown blindly into an area and then left to sit on one side so that the crevasses are elevated above a substantially horizontal surface such as a floor 50 and also disposed away from a vertical surface such as a wall 52. This distance is sufficient to allow insects such as ants or cockroaches to gain access to the insecticide disposed within these crevasses.

The body, crevasses, channels or indentations and the protrusions can be made in varying sizes so as to allow different kinds of insects access to the insecticide.

Accordingly, while several embodiments of the present invention have been shown and described, it is to be understood that many changes and modifications may be made thereunto without departing from the spirit and scope of the invention as defined in the appended claims.

1. A device for presenting insecticide comprising:
a) a base;
b) a plurality of channels for receiving insecticide; and
c) a plurality of protrusions extending from said base, said protrusions keeping said base off of an adjacent surface wherein said channels are radially spaced apart from each other in a substantially equidistant manner.

2. The device as in claim 1, wherein said base has a substantially circular cross section.

3. The device as in claim 1, wherein said base has a substantially polygonal cross section.

4. The device as in claim 3, wherein said base has a substantially square cross section.

5. The device as in claim 3, wherein said base has a substantially hexagonal cross section.

6. The device as in claim 1, wherein said plurality of channels are radially spaced apart from each other in a substantially equidistant manner.

7. The device as in claim 1, wherein said base is elongated and has a longitudinal axis wherein said plurality of channels extend along said longitudinal axis.

8. The device as in claim 1, wherein said plurality of protrusions are in the form of legs.

9. The device as in claim 1, wherein said plurality of protrusions are in the form of spikes.

10. A device for presenting insecticide comprising:
a) a base;
b) a plurality of channels having a continuous surface formed from said base, said channels for receiving insecticide; and
c) a plurality of protrusions extending from said base, said protrusions keeping said base off of an adjacent surface wherein said channels are radially spaced apart from each other in a substantially equidistant manner.
